(19) United States
(12) Patent Application Publication
(10) Pub. No.: US 2008/0098441 A1
(43) Pub. Date: Apr. 24, 2008

(54) Method and apparatus for managing services provided by devices in home network

(75) Inventor: Kyoung-ho Son, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/730,395

(22) Filed: Apr. 2, 2007

(30) Foreign Application Priority Data
Aug. 30, 2006 (KR) 10-2006-0082937

(51) Int. Cl. H04N 7/025

(52) U.S. Cl. 725/80; 725/82

(57) ABSTRACT

A method is provided for managing services provided by devices in a home network. A home network apparatus manages information related to services provided by all devices in a home network, and requests from a second device a substitute service capable of substituting for a service of a first device when the first device fails to provide the service. Accordingly, when a device from which a user requests a service cannot provide the service, the user does not need to directly search for a different device and again request the service from the different device.

### CROSS-REFERENCE TO RELATED PATENT APPLICATION

This application claims priority from Korean Patent Application No. 10-2006-0082937, filed on Aug. 30, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to a home network, and more particularly, to a method for effectively providing services of home network devices to users in a home network.

2. Description of the Related Art

As research into and standardization of home network technologies has progressed, an environment in which users can operate various home network devices using a single remote controller in the home is increasingly required. For example, in an environment in which a home network is established, a user can receive digital content from various network devices, such as a personal computer, a DVD player, etc., and watch the received digital content on a television.

Meanwhile, as various digital devices have become widely popular and a convergence phenomenon of such digital devices has been accelerated, instances of several devices providing the same or similar services in a home has increased. For example, two or more digital televisions installed in a home is commonplace.

FIG. 1 is a view for explaining a method of using services provided by devices in a general home network.

A user controls a control point (for example, a remote controller) including a user interface, thereby controlling a home network device, that is, a controlled device. The controlled device receives a service request from the control point, and informs the control point whether the corresponding service was successfully transmitted, through a response message.

For example, as illustrated in FIG. 1, a control point CP can control a controlled device CD1 and a controlled device CD2, thus using services of the respective controlled devices CD1 and CD2. In this example, it is assumed that the controlled device CD1 and the controlled device CD2 provide the same service. When a user requests a service of the controlled device CD1, if a response indicating that the corresponding service is not available is received, the user has to search for a device of the same type as the controlled device CD1. If the controlled device CD2 is searched for, it is determined whether the controlled device CD2 and the controlled device CD1 can provide the same service. If it is determined that the controlled device CD2 provides the same service, the user has to again request the service to the controlled device CD2,

That is, in a related art home network, when a user controls a control point and uses a service of a controlled device, if the controlled device cannot provide the service, the user has to search for a different controlled device and again request the service from the different controlled device.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus and method for searching for and requesting a different service from a device which is capable of substituting for a service without user intervention, when an arbitrary device cannot provide the service in a home network.

According to an aspect of the present invention, there is provided a method of managing a home network, including: recognizing that a first device fails to provide a service requested by a second device; searching for a substitute service among a plurality of services provided by a plurality of devices in the home network; and requesting the substitute service from a third device which provides the substitute service, according to the search result.

The method further includes: generating a database in which a substitute service and an address of a device which provides the substitute service are mapped with respect to each of the services provided by the devices in the home network, wherein the searching is performed with reference to the database.

The home network is a Universal Plug and Play (UPnP) network, and the generating of the database is performed with reference to a plurality of UPnP description documents received from the devices in the home network.

If a plurality of substitute services exist in correspondence to a service, the generating of the database comprises setting a priority for each of the substitute services.

In the setting of the priority, the priority is set according to network response speeds of a plurality of devices that provide the substitute services and/or hardware specifications of the devices that provide the substitute services.

In the setting of the priority, the priority of the devices that provide the substitute services is set according to a user input.

The method further includes subscribing for event messages for the services provided by the devices in the home network, wherein the home network is a Universal Plug and Play (UPnP) network, and recognizing that the first device fails to provide the service requested by the second device comprises receiving an event message from the first device.

A computer readable recording medium has embodied thereon a computer program for executing the method of managing a home network, including: recognizing that a first device fails to provide a service requested by a second device; searching for a substitute service among a plurality of services provided by a plurality of devices in the home network; and requesting the substitute service from a third device which provides the substitute service, according to the search result.

According to another aspect of the present invention, there is provided an apparatus for managing a home network, including: a recognition unit recognizing that a first device fails to provide a service requested by a second device; a search unit searching for a substitute service among a plurality of services provided by a plurality of devices in the home network; and a service request unit requesting the substitute service from a third device which provides the substitute service, according to the search result.

### BRIEF DESCRIPTION OF THE DRAWINGS

The above and other aspects of the present invention will become more apparent by describing in detail exemplary embodiments thereof with reference to the attached drawings in which:

FIG. 1 is a view for explaining a method of using services provided by devices in a related art home network;

FIG. 2 is a view for explaining a method of using a substitute service in a home network, according to an exemplary embodiment of the present invention;

FIG. 3 is a flowchart illustrating a method in which a home network management apparatus manages services provided by devices, according to an exemplary embodiment of the present invention;

FIG. 4 illustrates a structure of a service management database generated by a home network management apparatus, according to an exemplary embodiment of the present invention;

FIG. 5 is a view for explaining a process in which a substitute service is provided in a home network, according to an exemplary embodiment of the present invention;

FIG. 6 illustrates a home network environment according to an exemplary embodiment of the present invention; and

FIG. 7 is a block diagram of a home network management apparatus according to an exemplary embodiment of the present invention.

### DETAILED DESCRIPTION OF EXEMPLARY EMBODIMENTS OF THE INVENTION

Hereinafter, exemplary embodiments of the present invention will be described in detail with reference to the appended drawings.

In this specification, it is assumed that the home network is a Universal Plug and Play (UPnP) home network. UPnP allows communication between devices connected to a network, without complicated settings between the devices. UPnP allows a device to automatically search for a service belonging to a different device. In a UpnP home network, when a user only connects a device to the UPnP home network, other devices connected to the UPnP home network automatically find the newly connected device and perform various processes required for communication through information exchange. Accordingly, since UPnP allows easy installation of home network devices, UPnP is regarded as a core middleware for estimating a home network.

FIG. 2 is a view for explaining a method of using a substitute service in a home network, according to an exemplary embodiment of the present invention.

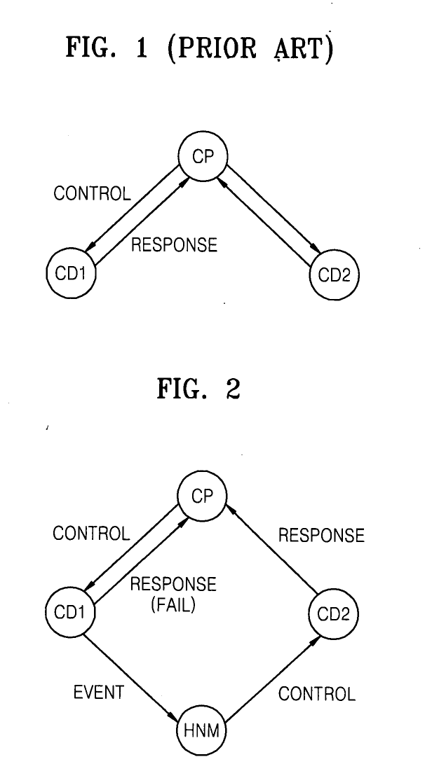

In FIG. 2, like FIG. 1, it is assumed that a first controlled device CD1 and a second controlled device CD2 provide the same service.

When a user requests a service to the first controlled device CD1 using a control point CP, if a response message indicating that the corresponding service is not provided is received from the first controlled device CD1, a home network management apparatus HNM according to an exemplary embodiment of the present invention receives the response message as an event message.

When a change occurs in a variable indicating a status of a service provided by a controlled device in a UPnP network, an event message is used to notify the change to a device which subscribes for event messages. Accordingly, the home network management apparatus HNM has to subscribe for event messages from all of the controlled devices in a home network.

If the home network management apparatus recognizes that the first controlled device CD1 cannot provide the service by receiving the event message from the first controlled device CD1, the home network management apparatus HNM determines whether a device providing a service capable of substituting for the service of the first controlled device CD1 exists in the home network. If the second controlled device CD2 is located, the home network management apparatus HNM requests the corresponding service from the second controlled device CD2, together with service request content (that is, a status variable, etc. included in a control message which the control point CP transfers to the first controlled device CD1) recognizable through the event message. Since the control message for requesting the service includes information indicating that the service is requested by the control point CP, the second controlled device CD2 transmits to the control point CP a response message indicating whether the service is successfully provided. It is also possible that the home network management apparatus HNM receives the response message from the second controlled device CD2 and transmits it to the control point CP.

In FIG. 2, the home network management apparatus HNM is shown as a separate device. However, it will be understood by those of ordinary skill in the art that the home network management apparatus HNM according to the exemplary embodiments of the present invention is a functional component (for example, the control point CP) capable of being included in a different home network device.

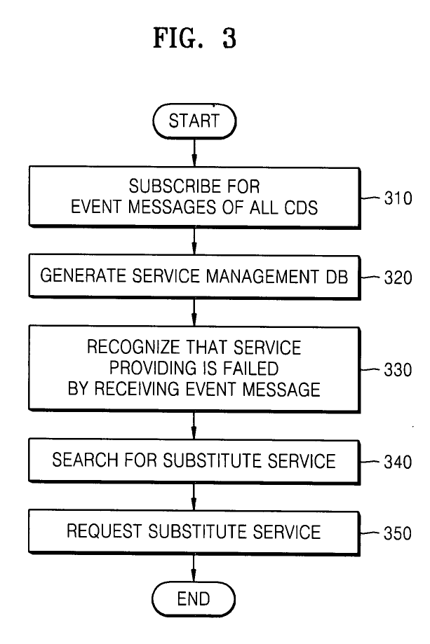

FIG. 3 is a flowchart illustrating a method in which a home network management apparatus manages services provided by devices, according to an exemplary embodiment of the present invention.

In operation 310, the home network management apparatus subscribes for event messages with respect to all of the controlled devices in a home network. The home network management apparatus subscribes for event messages with respect to controlled devices newly connected to the home network, as well as with respect to controlled devices already in the home network.

In operation 320, the home network management apparatus generates a service management database, wherein information for generating the service management database can be obtained by a UPnP description document. That is, if the home network management apparatus is initially connected to the home network, the home network management apparatus receives UPnP description documents for all controlled devices in the home network and generates the service management database with reference to the UPnP description documents. The service management database maps substitute services capable of respectively substituting for services, to addresses of controlled devices that provide the substitute services, and stores the results. “Substitute services” refer to services that can be substantially compatible with the corresponding services and do not indicate services provided by the same product with the same specification. In the UPnP description document, services capable of being used with the same type of device and services of the same type can be considered as substitutable services.

Meanwhile, when a new controlled device is connected to the home network while the home network management apparatus is connected to the home network, the home network management apparatus checks a device type and a service type of the new controlled device through a UPnP description document of the new controlled device, and updates the service management database. That is, if the same device type as the device type of the new controlled device does not exist in the service management database, the home network management apparatus newly registers the device type of the new controlled device, and if the same device type as the device type of the new controlled device exists in the service management database, the home network management apparatus searches for a service (services) capable of substituting for a service of the new controlled device from services mapped to the device type. If no service capable of substituting for the service of the new controlled device exists in the service management database, the home network management apparatus registers the service of the new controlled device as a new service, and if a service (services) capable of substituting for the service of the new controlled device exists in the service management database, the home network management apparatus maps the service of the new controlled device to an address of the new controlled device.

In operation 330, the home network management apparatus receives an event message indicating that provision of the service has failed. That is, since the home network management apparatus has subscribed for event messages from all of the controlled devices in operation 310, the home network management apparatus can recognize that a certain controlled device fails to respond to a service request from a control point. Here, the event message includes all contents of a response message which the controlled device which cannot provide the service transfers to the control point requesting the service.

In operation 340, the home network management apparatus searches for a substitute service capable of substituting for the service requested by the control point with reference to the service management database.

Then, in operation 350, the home network management apparatus requests the substitute service from a controlled device that provides the substitute service.

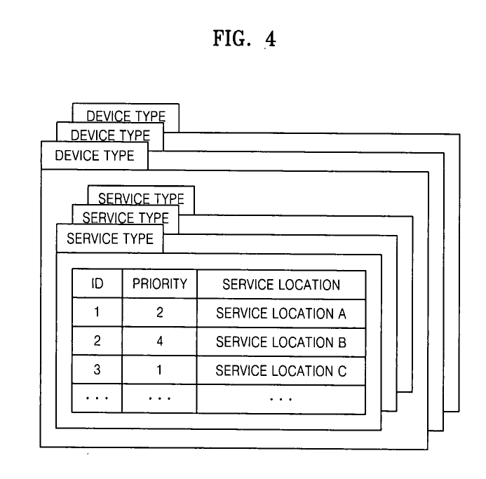

FIG. 4 illustrates the structure of the service management database generated by the home network management apparatus, according to an exemplary embodiment of the present invention.

As illustrated in FIG. 4, related service types are mapped to device types of controlled devices belonging to a home network. Also, if a plurality of substitute services are mapped to the same device type, the substitute services are mapped to address information of devices that provide the substitute services. That is, in FIG. 4, service locations A, B, C, . . . refer to address information of the devices.

If three or more substitute services exist, that is, if a plurality of substitute services exist with respect to a service, it is preferable that priority is assigned to the plurality of substitute services. Priority of the substitute services can be set, according to a network response speed of each of a plurality of devices that provide the substitute services and/or a hardware specification of each of the devices that provide the substitute services.

Also, priority of the substitute services can be set arbitrarily by a user through a user interface.

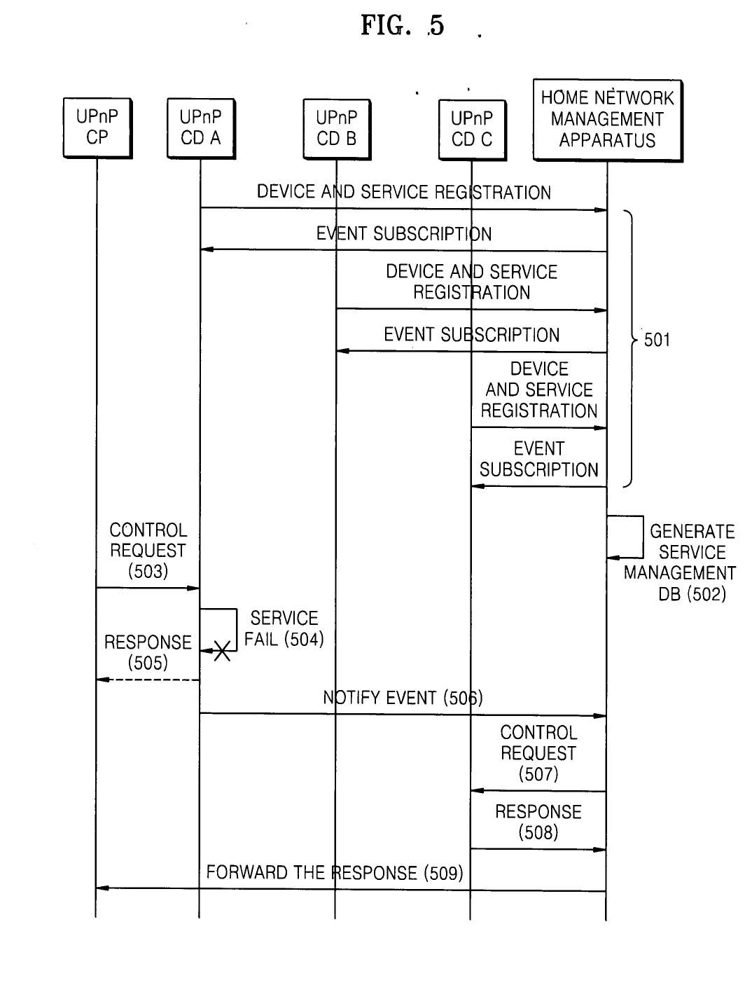

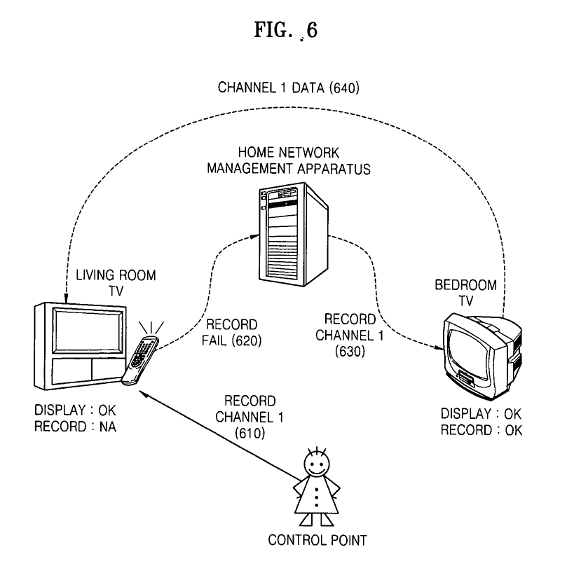

FIG. 5 is a view for explaining a process in which a substitute service is provided in a home network, according to an exemplary embodiment of the present invention. In FIG. 5, it is assumed that in the home network, a controlled device A, a controlled device B, and a controlled device C provide the same service.

In operation 501, a home network management apparatus finds controlled devices in the home network, receives UPnP description documents from the controlled devices, and subscribes for event messages from all of the controlled devices.

In operation 502, the home network apparatus generates (or updates) a service management database with reference to the UPnP description documents received from the controlled devices.

In operation 503, a control point transmits a control message for requesting a service to the controlled device A.

In operation 504, when the controlled device A fails to provide the service, the controlled device A transmits a response message indicating the failure to provide the service to the control point, in operation 505, and simultaneously transmits an event message to the home network management apparatus, in operation 506. As described above, content included in the response message transmitted in operation 505 is included in the event message transmitted in operation 506.

In operation 507, the home network management apparatus searches for a substitute service and requests the substitute service from the controlled device C. That is, although the controlled devices A, B, and C can provide the substitute service, the home network management apparatus transmits the control message to the controlled device C having the highest priority with reference to the service management database. Here, variables required for requesting the substitute service are the same as variables included in the control message transmitted in operation 503. The variables are included in the event message transmitted in operation 506 and transmitted to the home network management apparatus.

In operation 508, the controlled device C, which receives the substitute service request, transmits to the home network management apparatus a response message indicating whether the substitute service is successfully provided. In operation 509, the home network management apparatus forwards the response message to the control point.

It is also possible that the controlled device C directly transmits a response message to the control point instead of the home network management apparatus when the control message transmitted in operation 507 is equal to the control message transmitted in operation 503.

FIG. 6 illustrates a home network environment according to an exemplary embodiment of the present invention.

In the current exemplary embodiment, it is assumed that a TV located in a living room can provide a broadcast display service and cannot provide a recording service due to errors, but a TV located in a bedroom can provide both a broadcast display service and a recording service, when a user wants to record a channel No. 1 while watching it on the living room TV.

In operation 610, the user, who does not recognize that the living room TV cannot provide the recording service, requests the recording service from the living room TV using a remote controller (that is, a control point). In operation 620, the living room TV informs a home network management apparatus that the recording service cannot be provided by the living room TV, through an event message.

In operation 630, the home network management apparatus searches for a substitute service with reference to the event massage, recognizes that the bedroom TV can provide the recording service, and requests the bedroom TV to record the channel No. 1 using variables included in the event message.

In operation 640, if recording of the channel No. 1 is complete, recorded data stored in the bedroom TV is transmitted to the living room TV through the home network. If the recorded data is transmitted to the living room TV, the user can watch his or her desired broadcast on the living room TV.

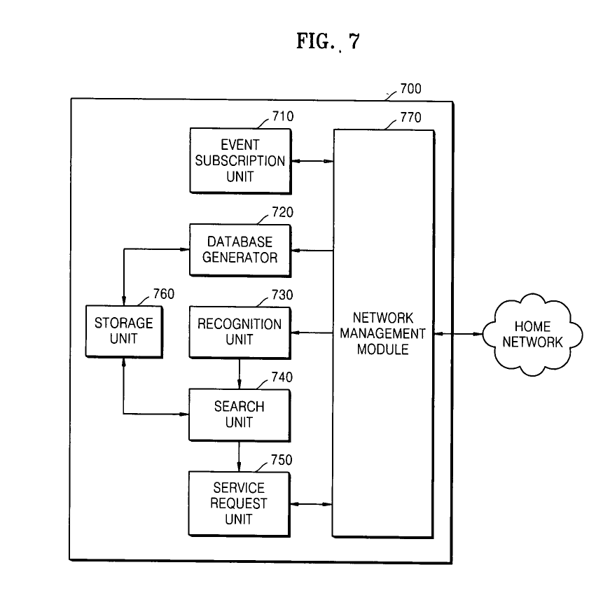

FIG. 7 is a block diagram of a home network management apparatus 700 according to an exemplary embodiment of the present invention.

Referring to FIG. 7, the home network management apparatus 700 includes an event subscription unit 710, a database generator 720, a recognition unit 730, a search unit 740, a service request unit 750, a storage unit 760, and a network management module 770.

The event subscription unit 710 subscribes for event messages of all controlled devices connected to a home network.

The database generator 720 generates a service management database so that the home network management apparatus 700 can find a substitute service (substitute services) with respect to a service (services) provided through the home network, with reference to UPnP description documents received from the controlled devices in the home network. As described above, if a plurality of substitute services exist with respect to a service, priority of the substitute services can be set, according to network response speeds of respective devices that provide the plurality of substitute services and/or hardware specifications of the respective devices that provide the plurality of substitute services. Also, priority of the substitute services can be set based on a value input through a user interface (not shown). The service management database is stored in the storage unit 760.

The recognition unit 730 recognizes that a controlled device cannot provide a requested service, through an event message received from the controlled device, and requests the search unit 740 to search for a substitute service.

The search unit 740 searches for a substitute service for a service specified by the event message, with reference to the service management database. If the corresponding substitute service is searched for, the search unit 740 transfers information required for requesting the substitute service to the service request unit 750.

The service request unit 750 requests the substitute service using the information received from the search unit 750.

The network management module 770 performs basic connection management so that all devices in the home network can communicate with each other. That is, in a UPnP home network, the network management module 770 executes basic protocols, such as Simple Object Access Protocol (SOAP), Simple Service Discovery Protocol (SSDP), etc., and receives or transmits messages related to respective operations for UPnP networking.

Meanwhile, the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

As described above, according to the exemplary embodiments of the present invention, when a device from which a user requests a service cannot provide the service in a home network including a plurality of devices, the user does not need to directly search for a different device and again request the service.

Also, by combining a plurality of substitute services that are provided to a plurality of devices in a home network with each other, on the basis of priority of the substitute services set according to the performance of the devices, users can be optimized.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of managing a home network, the method comprising:
recognizing that a first device fails to provide a service requested by a second device;
searching for a substitute service among a plurality of services provided by a plurality of devices in the home network; and
requesting the substitute service from a third device which provides the substitute service, according to a result of the searching.

2. The method of claim 1, further comprising:
generating a database in which the substitute service and an address of the device which provides the substitute service are mapped with respect to each of the services provided by the devices in the home network,
wherein the searching is performed with reference to the database.

3. The method of claim 2, wherein the home network is a Universal Plug and Play (UPnP) network, and the generating of the database is performed with reference to a plurality of UPnP description documents received from the devices in the home network.

4. The method of claim 2, wherein, if a plurality of substitute services exist in correspondence to the requested service, the generating of the database comprises setting a priority for each of the substitute services.

5. The method of claim 4, wherein, in the setting of the priority, the priority is set according to network response speeds of a plurality of devices that provide the substitute services or hardware specifications of the devices that provide the substitute services.

6. The method of claim 4, wherein, in the setting of the priority, a priority of the devices that provide the substitute services is set according to a user input.

7. The method of claim 1, further comprising subscribing for event messages for the services provided by the devices in the home network, wherein the home network is a Universal Plug and Play network, and the recognizing that the first device fails to provide the service requested by the second device comprises receiving an event message from the first device.

8. A computer readable recording medium having embodied thereon a computer program for executing a method of managing a home network, comprising:
recognizing that a first device fails to provide a service requested by a second device;
searching for a substitute service among a plurality of services provided by a plurality of devices in the home network; and
requesting the substitute service from a third device which provides the substitute service, according to a result of the searching.

9. An apparatus for managing a home network, the apparatus comprising:
a recognition unit which recognizes that a first device fails to provide a service requested by a second device;
a search unit which searches for a substitute service among a plurality of services provided by a plurality of devices in the home network; and
a service request unit which requests the substitute service from a third device which provides the substitute service, according to a result of the search by the search unit.

10. The apparatus of claim 9, further comprising a database generator which generates a database in which a substitute service and an address of a device which provides the substitute service are mapped with respect to each of the services provided by the devices in the home network,
wherein the search unit searches for the substitute service with reference to the database.

11. The apparatus of claim 10, wherein the home network is a Universal Plug and Play (UPnP) network, and the database generator generates the database with reference to UPnP description documents received from the devices in the home network.

12. The apparatus of claim 10, wherein, if a plurality of substitute services exist in correspondence to a service, the database generator sets a priority for each of the substitute services.

13. The apparatus of claim 12, wherein the database generator sets the priority according to network response speeds of a plurality of devices that provide the substitute services or hardware specifications of the devices that provide the substitute services.

14. The apparatus of claim 12, wherein the database generator sets a priority for devices that provide the substitute services, according to a user input.

15. The apparatus of claim 9, further comprising an event subscribing unit which subscribes for event messages for the services provided by the devices in the home network, wherein the home network is a Universal Plug and Play (network, and the recognition unit recognizes that the first device fails to provide the service requested by the second device with reference to a message received from the first device.
